(19) United States
(12) Patent Application Publication
(10) Pub. No.: US 2023/0134162 A1
(43) Pub. Date: May 4, 2023

(54) METHOD OF PROCESSING INFORMATION, ELECTRONIC DEVICE, AND STORAGE MEDIUM

(71) Applicant: BEIJING BAIDU NETCOM SCIENCE TECHNOLOGY CO., LTD., Beijing (CN)

(72) Inventor: Chunhui WAN, Beijing (CN)

(73) Assignee: BEIJING BAIDU NETCOM SCIENCE TECHNOLOGY CO., LTD., Beijing (CN)

(21) Appl. No.: 18/088,160

(22) Filed: Dec. 23, 2022

(30) Foreign Application Priority Data
Dec. 28, 2021 (CN) 202111628938.4

(51) Int. Cl. G06Q 20/40; G06Q 20/38; G06Q 30/0226; G06Q 20/10

(52) U.S. Cl. CPC G06Q 20/401; G06Q 20/389; G06Q 30/0226; G06Q 20/10; G06Q 20/3825; G06Q 20/3829; G06Q 2220/00

(57) ABSTRACT

A method of processing an information, an electronic device, and a storage medium, which relate to a field of a blockchain, in particular to fields of cloud computing and cloud service. The method includes: verifying a transaction request in response to the transaction request being received, wherein the transaction request includes a transaction information and an incentive information for the transaction information; storing the transaction information on a blockchain in response to the transaction request being verified successfully, so as to obtain an updated blockchain; updating a first existing incentive point according to the incentive information, so as to obtain an updated incentive point; and broadcasting the updated blockchain and the updated incentive point to a plurality of blockchain nodes in a blockchain network, wherein the incentive information includes a first quantity of incentive points, and each incentive point corresponds to a first predetermined quantity of resources.

This application claims priority of Chinese Patent Application No. 202111628938.4 filed on Dec. 28, 2021, which is incorporated herein in its entirety by reference.

### TECHNICAL FIELD

The present disclosure relates to a field of a blockchain technology, specifically to fields of cloud computing and cloud service technologies, and in particular to a method of processing an information, an electronic device, and a storage medium.

### BACKGROUND

With a rapid development of the Internet and a computer technology, a development of a digital economy is gradually accelerating, a scope of radiation of the digital economy is gradually increasing, and a degree of influence of the digital economy is gradually deepening, which puts forward a higher requirement for a reliable transmission of information. In the traditional Internet, an information transmission is performed mainly by means of copying, which is not suitable for a transfer of a digital asset in the digital economy.

### SUMMARY

The present disclosure provides a method of processing an information, an electronic device, and a storage medium.

According to an aspect of the present disclosure, a method of processing an information is provided, including: verifying a transaction request in response to the transaction request being received, wherein the transaction request includes a transaction information and an incentive information for the transaction information; storing the transaction information on a blockchain in response to the transaction request being verified successfully, so as to obtain an updated blockchain; updating a first existing incentive point according to the incentive information, so as to obtain an updated incentive point; and broadcasting the updated blockchain and the updated incentive point to a plurality of blockchain nodes in a blockchain network, wherein the incentive information includes a first quantity of incentive points, and each incentive point corresponds to a first predetermined quantity of resources.

According to another aspect of the present disclosure, a method of processing an information is provided, including: determining an incentive information for a transaction information in response to the transaction information being received; sending a transaction request to a blockchain network to store the transaction information on a blockchain, wherein the transaction request includes the transaction information and the incentive information; and updating a second existing incentive point according to the incentive information, wherein the incentive information includes a first quantity of incentive points, and each incentive point corresponds to a first predetermined quantity of resources.

According to another aspect of the present disclosure, an electronic device is provided, including: at least one processor; and a memory communicatively connected to the at least one processor, wherein the memory stores instructions executable by the at least one processor, and the instructions, when executed by the at least one processor, cause the at least one processor to implement the method of processing the information provided by the present disclosure.

According to another aspect of the present disclosure, a non-transitory computer-readable storage medium having computer instructions therein is provided, and the computer instructions are configured to cause a computer to implement the method of processing the information provided by the present disclosure.

It should be understood that content described in this section is not intended to identify key or important features in embodiments of the present disclosure, nor is it intended to limit the scope of the present disclosure. Other features of the present disclosure will be easily understood through the following description.

### BRIEF DESCRIPTION OF THE DRAWINGS

The accompanying drawings are used for better understanding of the solution and do not constitute a limitation to the present disclosure, in which:

FIG. 1 shows a schematic diagram of an application scenario of a method and an apparatus of processing an information according to embodiments of the present disclosure;

FIG. 2 shows a schematic flowchart of a service end-based method of processing an information according to embodiments of the present disclosure;

FIG. 3 shows a schematic flowchart of a blockchain-based method of processing an information according to embodiments of the present disclosure;

FIG. 4 shows a schematic flowchart of exchanging points according to embodiments of the present disclosure;

FIG. 5 shows a schematic diagram of verifying a transaction request according to embodiments of the present disclosure;

FIG. 6 shows a structural block diagram of a blockchain-based apparatus of processing an information according to embodiments of the present disclosure;

FIG. 7 shows a structural block diagram of a service end-based apparatus of processing an information according to embodiments of the present disclosure; and

FIG. 8 shows a block diagram of an electronic device for implementing a method of processing an information of embodiments of the present disclosure.

### DETAILED DESCRIPTION OF EMBODIMENTS

Exemplary embodiments of the present disclosure will be described below with reference to accompanying drawings, which include various details of embodiments of the present disclosure to facilitate understanding and should be considered as merely exemplary. Therefore, those ordinary skilled in the art should realize that various changes and modifications may be made to embodiments described herein without departing from the scope and spirit of the present disclosure. Likewise, for clarity and conciseness, descriptions of well-known functions and structures are omitted in the following description.

The present disclosure provides a method of processing an information, which includes a request verification stage, an information storage stage, a point update stage, and an information broadcast stage. In the request verification stage, a transaction request is verified in response to the transaction request being received, and the transaction request includes the transaction information and an incentive information for the transaction information. In the information storage stage, in response to the transaction request being verified successfully, the transaction information is stored on a blockchain to obtain an updated blockchain. In the point update stage, a first existing incentive point is updated according to the incentive information to obtain an updated incentive point. In the information broadcast stage, the updated blockchain and the updated incentive point are broadcast to a plurality of blockchain nodes in a blockchain network. The incentive information includes a first quantity of incentive points, and each incentive point corresponds to a first predetermined quantity of resources.

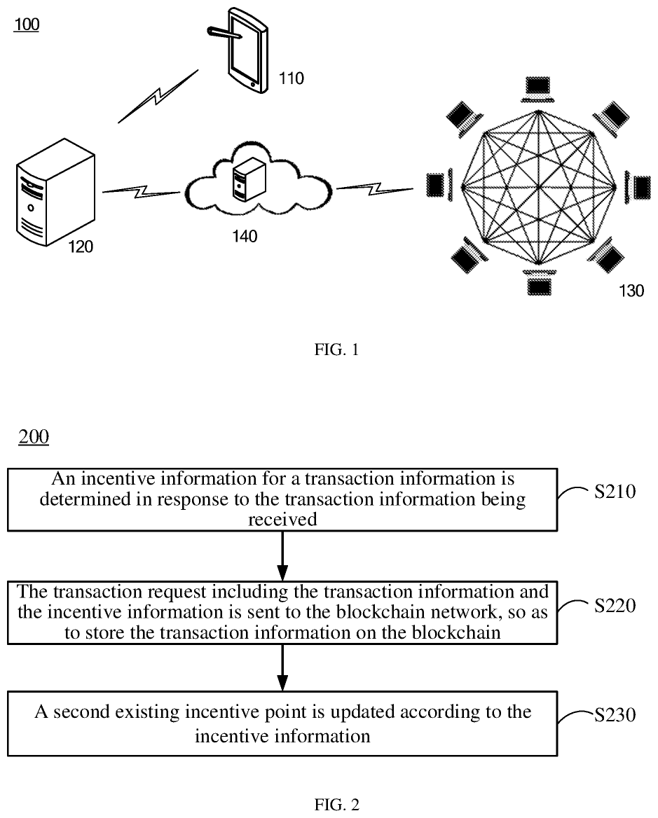

An application scenario of a method and an apparatus provided by the present disclosure will be described below with reference to FIG. 1.

FIG. 1 shows a schematic diagram of an application scenario of a method and an apparatus of processing an information according to embodiments of the present disclosure.

As shown in FIG. 1, an application scenario 100 of such embodiments may include a terminal device 110, a server 120, and a blockchain network 130. The terminal device 110 may be communicatively connected to the server 120 through a network, and the server 120 may be communicatively connected to a blockchain node in the blockchain network 130 through a network. The blockchain network 130 may include a plurality of blockchain nodes, and the plurality of blockchain nodes are communicatively connected to each other through a network. The network may include wired or wireless communication links.

The terminal device 110 may be a smart phone, a tablet computer, a laptop computer, a desktop computer, or the like. The terminal device 110 may be installed with game applications, shopping applications, audio-visual playing applications, or the like. Various types of applications may be used by a user, for example, by using the terminal device 110, and a digital asset may be held by the user, for example, in at least one application. The digital asset may be a non-fungible token corresponding to a game prop, an electronic artwork, a sale of houses, or the like.

The server 120 may be, for example, a background management server that supports running of an application in the terminal device 110. For example, a transaction request for the digital asset may be initiated by the user through the terminal device 110, so that other users of the blockchain network may view their digital assets and perform transfer transactions of digital assets. For example, the terminal device 110 may send a transaction request to the blockchain network 130 via the background management server 120 in response to a user operation, so as to generate a block based on a transaction information of the digital asset and add the block to the blockchain, so that a decentralized registration and transfer of the digital asset may be achieved.

In an embodiment, a service end 140 may be provided between the background management server 120 and the blockchain network 130. The transaction request for the digital asset initiated by the terminal device 110 may be forwarded to the service end 140 via the background management server 120, and then forwarded to the blockchain network 130 by the service end 140. The service end 140 may be, for example, a Software as a Service (SaaS) platform, a Backend as a Service (BaaS) platform, or the like. The service end 140 may provide, for example, an enterprise-level platform service based on a blockchain technology, so as to provide a reliable service for a digital asset transaction.

In an embodiments, for example, the service end 140 may maintain accounts of at least two applications in the terminal device, and provide blockchain accounts for the at least two applications. The terminal device may initiate, for example, a transaction request via the blockchain account. The service end 140 may further access an asset supervisory agency to verify a legitimacy of each digital asset requested for transaction, and only a transaction request for a legal digital asset is allowed. In this way, the service end 140 may benefit a healthy development of the digital economy.

The blockchain network 130 may achieve a decentralized management of the digital asset, for example, through distributed ledgers and Byzantine fault-tolerant consensus, combined with technologies such as cryptography and peer-to-peer communication.

It should be noted that one method of processing an information provided in the present disclosure may generally be performed by a blockchain node in the blockchain network 130, and another method of processing an information provided in the present disclosure may generally be performed by the service end 140. Accordingly, one apparatus of processing an information provided in the present disclosure may be provided in a blockchain node in the blockchain network 130, and another apparatus of processing an information provided in the present disclosure may be provided in the service end 140.

It should be understood that a number and a type of terminal device, server, service end and blockchain network in FIG. 1 are merely schematic. According to implementation needs, any number and type of terminal devices, servers, service ends and blockchain networks may be provided.

The methods of processing the information provided by the present disclosure will be described in detail below through FIG. 2 to FIG. 5 with reference to FIG. 1.

FIG. 2 shows a schematic flowchart of a service end-based method of processing an information according to embodiments of the present disclosure.

As shown in FIG. 2, a method 200 of processing an information of such embodiments includes operation S210 to operation S230. The method of processing the information may be performed by a service end, and the service end may be a SaaS platform.

In operation S210, an incentive information for a transaction information is determined in response to the transaction information being received.

According to embodiments of the present disclosure, the transaction information may be transmitted by a user using a blockchain account via a terminal device. The transaction information may include, for example, an information of a digital asset that needs to be issued to the blockchain, or may include an information of a digital asset that needs to be transferred. The information of the digital asset may include, for example, an asset holder accounts, an asset description information, an asset category, an asset transaction type, and other information.

According to embodiments of the present disclosure, the incentive information may include a first quantity of incentive points. The first quantity may have a mapping relationship with the asset transaction type. Alternatively, for any type of transaction, the first quantity contained in the incentive information may be a predetermined value. The incentive point may be used to, for example, exchange resources, and each incentive point may correspond to a first predetermined quantity of resources. Through the incentive point, a blockchain node may be incentivized to participate in a maintenance of a normal operation of the blockchain network. Each blockchain node may be associated with one or at least two applications, each application may be provided with a plurality of blockchain accounts according to requirements, and each blockchain node may be provided with a blockchain account. The incentive point may come from, for example, an account requesting a transaction (that is, a transaction request account) among the plurality of blockchain accounts, and may be transferred by the transaction request account to a blockchain account configured for a blockchain node storing the transaction information on the blockchain, so as to achieve an incentive to the blockchain account configured for the blockchain node storing the transaction information.

After the incentive information is determined, the incentive information may be packaged with the transaction information to form a transaction request. Then operation S220 may be performed to send the transaction request including the transaction information and the incentive information to the blockchain network, so as to store the transaction information on the blockchain.

According to embodiments of the present disclosure, after determining the incentive information for the transaction information and forming the transaction request, the service end may send the transaction request to the blockchain network. After the transaction request is verified by using a smart contract, the blockchain network may add the transaction information in the transaction request to the blockchain in a form of a block.

For example, the blockchain node in the blockchain network may firstly encrypt the transaction information, a time information and encryption data of a latest block on the blockchain, and then add the encrypted data as a new block to an end of the blockchain, so as to complete a storage of the transaction information.

The blockchain node adding the transaction information to the blockchain in the form of a block may be a blockchain node associated with the application that the transaction request account belongs to, or any blockchain node in the blockchain network that is elected and determined as a consensus node. For example, each blockchain node in the blockchain network may be associated with at least one application in the terminal device, and specifically may be associated with a blockchain account provided by the at least one application. The blockchain account configured for each blockchain node may be independent of the at least one application. After the blockchain node completes the storage of the transaction information, the blockchain node may update an existing incentive point of a corresponding blockchain account according to the incentive information in the transaction request.

In operation S230, a second existing incentive point is updated according to the incentive information.

After the service end sends the transaction request to the blockchain network, the existing incentive point of the transaction request account may be updated according to the determined incentive information. Specifically, the first quantity contained in the incentive information may be subtracted from the quantity of the existing incentive point, so as to update the existing incentive point. Alternatively, the service end may determine a state of the transaction information in the blockchain network through a communication with the blockchain network, and determine whether the transaction information has been stored in the blockchain according to the state. For example, after storing the transaction information on the blockchain, the blockchain network may feed back an information indicating the completion of the storage to the service end. After determining that the transaction information is stored on the blockchain, the service end may update the existing incentive point of the transaction request account according to the determined incentive information.

Through the method of processing the information of embodiments of the present disclosure, the incentive point corresponding to the first predetermined quantity of resources may be used to incentivize the blockchain node in the blockchain network that encrypts the transaction information to form the block. In this way, it is possible to avoid speculating on incentive points, which is conducive to the healthy development of the digital economy, and an incentive manner may not be affected by a policy restriction, so that an applicability of the method of processing the information may be improved.

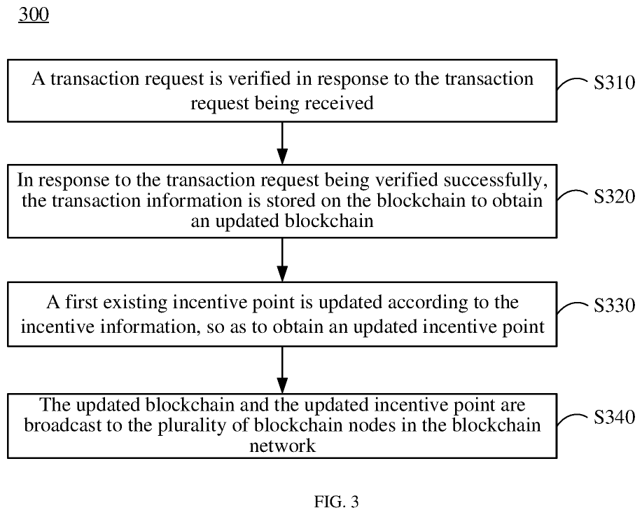

According to the service end-based method of processing the information, the present disclosure further provides a blockchain-based method of processing an information, which will be described in detail below with reference to FIG. 3.

FIG. 3 shows a schematic flowchart of a blockchain-based method of processing an information according to embodiments of the present disclosure.

As shown in FIG. 3, a blockchain-based method 300 of processing an information of such embodiments may include operation S310 to operation S340.

In operation S310, a transaction request is verified in response to the transaction request being received.

According to embodiments of the present disclosure, the transaction request may contain a transaction information and an incentive information for the transaction information. The transaction request may be formed by a service end packaging the incentive information and the transaction information, and the transaction request may be transmitted by the service end to a blockchain network, specifically to a blockchain node associated with the application that the transaction request account belongs to. After receiving the transaction request, the blockchain node may transmit the transaction request to a plurality of blockchain nodes communicatively connected to the blockchain node in the blockchain network, so as to perform a consensus verification. In this way, each blockchain node in the blockchain network that receives the transaction request may verify the transaction request.

According to embodiments of the present disclosure, a blockchain node may verify an authenticity of the transaction request by calling a smart contract. For example, the transaction information in the transaction request may include a public key of the transaction request account, a signature of the transaction request account, or the like. The blockchain node may decrypt the signature using the public key. In a case of a successful decryption, it may be determined that the transaction request is verified successfully, data or files in the transaction request are complete and accurate, and the transaction information in the transaction request comes from a blockchain account having a private key. The private key is a key paired with the public key of the transaction request account.

In operation S320, in response to the transaction request being verified successfully, the transaction information is stored on the blockchain to obtain an updated blockchain.

According to embodiments of the present disclosure, whether the transaction request is verified successfully may be determined according to verification results of the plurality of blockchain nodes by using a consensus mechanism such as Byzantine. For example, if a predetermined proportion of nodes in the plurality of blockchain nodes determine that the transaction request is verified successfully, the blockchain node storing the transaction information on the blockchain may determine that the transaction request is verified successfully by the blockchain network, and then operation S320 may be performed. It may be understood that the aforementioned predetermined proportion may be, for example, ⅔, and the predetermined proportion and the above-mentioned consensus mechanism are merely used as examples to facilitate the understanding of the present disclosure. Any consensus mechanism may be used in the present disclosure to determine whether the transaction request is verified successfully by the blockchain network.

According to embodiments of the present disclosure, for example, a blockchain node may firstly encrypt a transaction information, a time information, and encryption data of a latest block on the blockchain, generate a new block according to the encrypted data, and store the new block to the end of the blockchain, so as to complete a storage of the transaction information and obtain an updated blockchain. The transaction information, the time information, and the encryption data of the latest block in the blockchain may be encrypted using a hash algorithm.

In operation S330, a first existing incentive point is updated according to the incentive information, so as to obtain an updated incentive point.

A quantity of the existing incentive point may be added to the first quantity of incentive points contained in the incentive information to obtain an updated quantity, so as to complete the update of the first existing incentive point and obtain the updated incentive point. The first existing incentive point is a point of the blockchain account configured for the blockchain node storing the transaction information on the blockchain.

In operation S340, the updated blockchain and the updated incentive point are broadcast to the plurality of blockchain nodes in the blockchain network.

After the updated blockchain and the updated incentive point are broadcast to the plurality of blockchain nodes, the plurality of blockchain nodes may update a locally stored blockchain and a ledger that records a transfer of points, so that a decentralized management of the transaction information and the incentive point may be achieved.

Through the method of processing the information of embodiments of the present disclosure, the incentive point corresponding to the first predetermined quantity of resources may be used to incentivize the blockchain node in the blockchain network that encrypts the transaction information to form the block. In this way, it is possible to avoid speculating on incentive points, which is conducive to the healthy development of the digital economy, and an incentive manner may not be affected by a policy restriction, so that an applicability of the method of processing the information may be improved.

It may be understood that the transaction request may be a first request to issue a digital asset to the blockchain, or a second request to transfer a digital asset from a first blockchain account to a second blockchain account. That is, the transaction request may include a request to issue a new digital asset, or a request to grant or transfer a digital asset. The transaction information in the transaction request may be sent by the terminal device in response to a user operation.

In an embodiment, after receiving the transaction information, the service end may perform, for example, an integrity verification on the transaction information, so as to ensure a smooth progress of the transaction and avoid a waste of computing resources.

For example, the digital asset may be a virtual asset or a token corresponding to a physical asset. The digital asset may be either a fungible token or a non-fungible token (NFT). In the present disclosure, representations of various types of digital assets to be issued may be standardized, so that a transaction circulation between different types of digital assets may be performed in the blockchain network according to the transaction information sent by the terminal device. For example, the standardized representation may include a serial number of the digital asset, a number of copies of the digital asset, a description information of the digital asset, a unique random number used for a signature de-duplication, a blockchain account issuing the digital asset, a public key of the blockchain account issuing the digital asset, a signature of the blockchain account issuing the digital asset, and so on. It may be understood that the information contained in the standardized representation may be set according to actual needs, which is not limited in the present disclosure. The above-mentioned integrity verification may be performed to verify whether all standardized representations of the digital asset to be traded are contained in the transaction information. If all standardized representations are contained, it is determined that the integrity verification is successful, and the incentive information for the transaction information may be determined. Otherwise, it is determined that the integrity verification fails, then the service end may feed back a prompt information or a check page to the terminal device via the background management server, so as to prompt the transaction request account to supplement the transaction information.

The serial number of the digital asset and the unique random number may be assigned, for example, by the application the blockchain account belongs to. The serial number of the digital asset may include, for example, an identification of the application, so as to ensure a global uniqueness of the serial number. The signature may be obtained by encrypting, for example, by using the private key of the blockchain account, a character string and a unique random number of the transaction information obtained by using a digital digest technology. An elliptic curve encryption algorithm may be used for encryption, which is not limited in the present disclosure. The description information of the digital asset may include a title of the digital asset, a category of the digital asset, an acquisition address of the digital asset, a picture information of the digital asset and/or a text information of the digital asset, etc. The description information of the digital asset may be selected according to actual needs, which is not limited in the present disclosure. It should be noted that, when the digital asset is a non-fungible token, the standardized representation may further include, for example, the identification information of each sub-asset in the digital asset.

In an embodiment, the transaction request may be broadcast to the plurality of blockchain nodes by any blockchain node in the blockchain network. Therefore, any blockchain account provided in any application in the at least two applications associated with the plurality of blockchain nodes may be used as the transaction request account. The node storing the transaction information on the blockchain may be a consensus node in the plurality of blockchain nodes, and the first existing incentive point is the existing incentive point of the consensus node storing the transaction information on the blockchain. The consensus node may be elected from the plurality of blockchain nodes by using a Delegated Proof of Stake (DPoS) or any consensus mechanism. In this way, a fixed number of nodes may be elected to be responsible for the consensus of the network, which facilitates an improvement of a consensus efficiency. The node storing the transaction information may be any one of the elected consensus nodes responsible for consensus. Accordingly, the aforementioned blockchain nodes verifying the transaction information are the elected consensus nodes. Besides, all normally operating nodes in the blockchain network may participate in ledgering as supervisory nodes to receive the transaction request and provide a transaction information verification function for the blockchain accounts, so as to ensure a credibility of the network. Accordingly, the updated blockchain and the updated incentive point may be broadcast to all normally operating nodes.

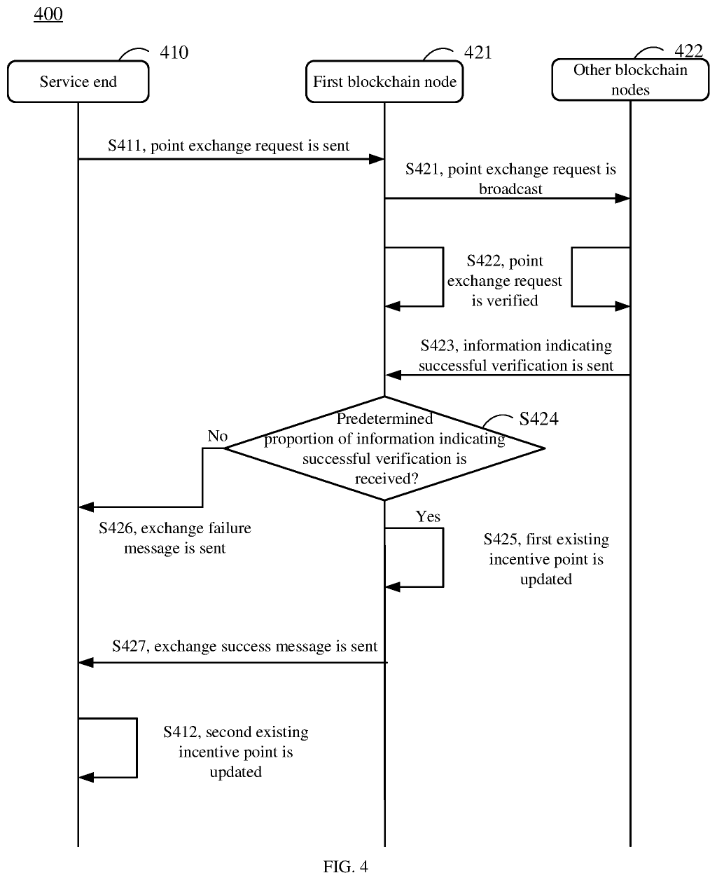

FIG. 4 shows a schematic flowchart of exchanging points according to embodiments of the present disclosure.

According to embodiments of the present disclosure, the service end may send a point exchange request to the blockchain network as needed, so as to exchange incentive points with resources when a blockchain account has only a few existing incentive points. This makes it easier for the blockchain account to initiate a transaction request. Moreover, since the point may be transferred between the service side and the blockchain network, it is possible to avoid an outflow of incentive points and avoid a speculation and illegal circulation of incentive points, so that the credibility of the blockchain network may be further improved, which is conducive to improving the healthy development of the digital economy. The resources may be, for example, a legal currency or the like.

As shown in FIG. 4, in an embodiment 400, operation S411 may be performed by a service end 410 to send a point exchange request to the blockchain network, in response to a second existing incentive point of a blockchain account being less than a predetermined value.

In an embodiment, operation S411 may be performed by the service end 410 in response to an exchange information sent by any blockchain account of any application in the at least two applications. The blockchain account may send the exchange information when the existing incentive point is less than the predetermined value. The exchange information may include a second quantity of incentive points requested for exchange. Besides, the blockchain account may further provide a certain amount of resources to an operator of the service end 410 online or offline. The service end 410 may pack the second quantity of incentive points requested for exchange and the third quantity of resources into a point exchange request. It may be understood that the quantity of the certain amount of resources may be, for example, greater than the third quantity, and a difference may be used as an operation reward for the operator of the service end. The third quantity of resources corresponds to the second quantity of incentive points.

After sending the point exchange request, the service end may update the existing incentive point of the aforementioned blockchain account (that is, the second existing incentive point) according to the second quantity.

In an embodiment, the point exchange request may be sent to any blockchain node in the blockchain network. The blockchain node may broadcast the point exchange request to other blockchain nodes. Each node in the blockchain network that receives the point exchange request may verify the point exchange request. If a predetermined proportion of nodes determine that the point exchange request is verified successfully, it may be determined that the second quantity and the third quantity in the point exchange request are accurate, and then a node having an intention of exchange in the plurality of blockchain nodes may update its existing incentive point according to the second quantity, and broadcast the updated existing incentive point to all blockchain nodes to complete the point exchange. It may be understood that when a plurality of nodes have an intention to exchange, a node that firstly broadcasts the existing incentive point may be a node that finally succeeds in the exchange. For example, a time stamp of the broadcasted existing incentive point may be used as a criterion for determination.

In an embodiment, for example, a first user of a blockchain account may negotiate offline with a second user of a blockchain account with a large number of incentive points, and negotiate to determine that the second user may transfer incentive points to the first user. In this case, the exchange information sent by the blockchain account may further include the blockchain account of the second user. Accordingly, the service end 410 may send the point exchange request to the blockchain node (for example, a first blockchain node 421) provided with the blockchain account of the second user. After the first blockchain node 421 receives the point exchange request, operation S421 may be performed to broadcast the point exchange request to other block chain nodes 422. Subsequently, both the first blockchain node 421 and the other block chain nodes 422 perform operation S422 to verify the point exchange request. After the other blockchain nodes 422 determine that the point exchange request is verified successfully, operation S423 may be performed to send a target information indicating that the point exchange request is verified successfully to the first blockchain node 421. The first blockchain node 421 may perform operation S424 to determine whether the target information indicating that the point exchange request is verified successfully is received from a predetermined proportion of nodes. If yes, operation S425 is performed to update the first existing incentive point, that is, update the existing incentive point of the blockchain account of the second user. Otherwise, the first blockchain node 421 may perform operation S426 to send an exchange failure message to the service end 410. The service end 410 may forward the exchange failure message to the blockchain account of the first user. After the first blockchain node 421 updates the first existing incentive point, operation S427 may be performed to send an exchange success message to the service end 410, and the service end 410 may forward the exchange success message to the blockchain account of the first user.

In an embodiment, the service end 410 may perform operation S412 to update the second existing incentive points, that is, update the existing incentive point of the blockchain account of the first user, after receiving the exchange success message. If the service end has updated the second existing incentive point after sending the point exchange request, then after receiving the exchange failure message, the service end may further change the second existing incentive point to a value before sending the point exchange request.

In an embodiment, the plurality of blockchain accounts provided with each application may include a management account. A transaction request initiated by any blockchain account may be sent to the blockchain network via the management account. Therefore, the aforementioned second existing incentive point may be an existing incentive point of a target account. The target account is the management account of any one of the at least two applications. The aforementioned transaction information may be sent to the service end 410 by any one of the at least two blockchain accounts contained in the application the target account belongs to, and the service end 410 may send a transaction request via the target account. Therefore, only the management account has a significance of maintaining incentive points, and the aforementioned exchange information may be sent to the service end 410 by any management account. In this way, it is possible to avoid a poor user experience caused by a case where any blockchain account needs to exchange incentive points, and thus improve a user experience. It may be understood that the management account may be, for example, a blockchain account of an application operator.

Exemplarily, the transaction information sent by any account may include the signature of the aforementioned blockchain account, so as to avoiding a tampering of the transaction information while improving the user experience, which is beneficial to ensure a compliance governance of the transaction and improve the credibility of the transaction.

Exemplarily, each blockchain node may call a smart contract for incentive points to verify the point exchange request. The smart contract for incentive points may specify, for example, a whitelist of point transfer paths. The exchange information contained in the point exchange request may further include a second transfer path, which may be represented by, for example, the blockchain account of the second user and/or the blockchain account of the first user. Such embodiments may be implemented to verify whether the transfer path belongs to a predetermined path by calling the smart contract for points. If the transfer path belongs to the predetermined path, it is determined that the point exchange request is verified successfully.

For example, the predetermined path may include a predetermined blockchain account, that is, the aforementioned whitelist of point transfer paths may be a whitelist of blockchain accounts, and the blockchain accounts in the whitelist of blockchain accounts include the management account of each application in the at least two applications. If the blockchain account representing the second transfer path belongs to the whitelist, it is determined that the point exchange request is verified successfully. It may be understood that the smart contract for points may be configured, for example, in a genesis block of the blockchain. Through the setting of the smart contract for incentive points, it is possible to control the circulation of incentive points, further restrict the outflow of incentive points, and avoid the speculation and illegal circulation of incentive points. It may be understood that the whitelist of blockchain accounts may further include the blockchain account configured for the consensus node.

In an embodiment, the service end may further communicate with a regulator, etc. to regularly acquire a list of non-compliant digital asset numbers, etc., and set a state of a digital asset corresponding to the digital asset number in the list to a transaction prohibited state. After receiving the transaction information, the service end may firstly determine a state information of the digital asset to be traded according to the digital asset number in the transaction information. If the state information is not the transaction prohibited state, it may be determined that the state information is a transaction allowed state. Then the incentive information for the transaction information may be determined. In this way, the compliance and legitimacy of the transaction may be guaranteed to a certain extent, and the healthy development of the digital economy may be further promoted.

In an embodiment, the incentive points may be issued by the blockchain network when the genesis block is generated, and no additional issuance will be made. That is, after the genesis block is generated, a total number of incentive points owned by all blockchain accounts is a fixed second predetermined quantity. In this way, it is possible to ensure the circulation of incentive points, and further avoid the speculation of incentive points.

It may be understood that, in a case of electing a consensus node using a consensus mechanism, the first blockchain node 421 and the other blockchain nodes 422 described above may both be consensus nodes.

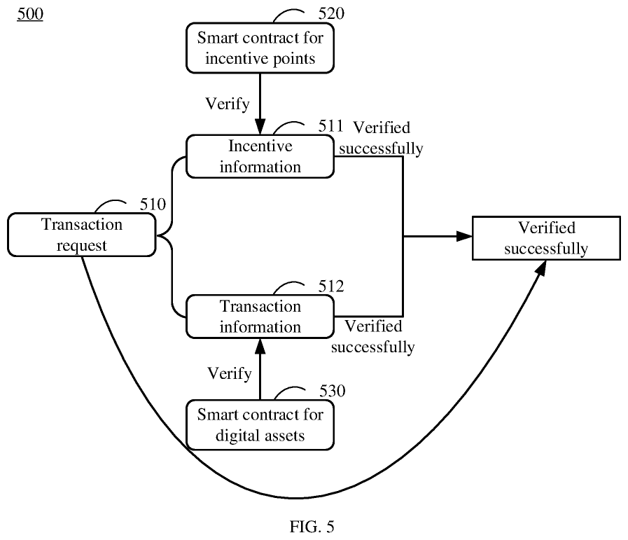

FIG. 5 shows a schematic diagram of verifying a transaction request according to embodiments of the present disclosure.

In an embodiment, when the blockchain node in the blockchain network verifies the transaction request, the incentive information may be verified to ensure that the transfer path of the incentive point is a predetermined path. In this way, the circulation of incentive points may be controlled, the outflow of incentive points may be limited, and the speculation and illegal circulation of incentive points may be avoided.

For example, the incentive information may be verified by using the aforementioned smart contract for points. The incentive information may include a first point transfer path. The first point transfer path may be represented by, for example, a blockchain account sending the transaction information.

In an embodiment, when the transaction request is verified, the transaction information and the incentive information contained in the transaction request may be verified using different smart contracts.

As shown in FIG. 5, in an embodiment 500, for a blockchain node that receives a transaction request 510, a smart contract 520 for incentive points may be called to verify an incentive information 511 to determine whether the first point transfer path belongs to a predetermined path, that is, determine whether the blockchain account in the incentive information 511 belongs to a whitelist of blockchain accounts. If so, it is determined that the incentive information is verified successfully. Besides, the blockchain node may call a smart contract 530 for digital assets to verify the transaction information. If both the incentive information 511 and the transaction information 512 are verified successfully, it may be determined that the transaction request is verified successfully.

The transaction information may contain, for example, the signature of the transaction request account and the public key of the transaction request account, and the smart contract for digital asset in such embodiment may verify the transaction information 512 according to the signature and the public key. For example, the signature may be decrypted using the public key, and if the decryption is successful, it is determined that the transaction information 512 is verified successfully.

According to embodiments of the present disclosure, the blockchain network may store the transaction information in a form of a key-value pair. The service end may acquire various transaction information, for example, by providing a service interface. For example, the service end may provide the following service interfaces.

Digital asset issuing interface: incoming parameters may include a blockchain account issuing the digital asset, a number of copies of the digital asset, a serial number of the digital asset, a unique random number used for signature de-duplication, a public key of the blockchain account issuing the digital asset, a signature of the blockchain account issuing the digital asset, an identification of an application of the blockchain account issuing the digital asset, and so on. The incoming parameters are parameters contained in the aforementioned transaction information. It should be noted that when the issued digital asset is a non-fungible token, a serial number of a sub-asset may be passed in for each sub-asset included in the digital asset. The non-fungible token may represent a unique asset such as houses. When a user has a plurality of houses, a number different from other types of assets may be set for the asset of the house type as the number of the digital asset. Besides, a number different from other houses may be set for each of the plurality of houses, so as to obtain the number of the sub-asset.

Digital asset grant interface: used to grant an ownership of a digital asset to a blockchain account. The incoming parameters may include the serial number of the digital asset, the serial number of the sub-asset included in the digital asset which is a non-fungible token, the unique random number used for signature de-duplication, the identification of the blockchain account issuing the digital asset, the identification of the blockchain account that receives the digital asset, the public key of the blockchain account issuing the digital asset, the signature of the blockchain account issuing the digital asset, the identification of the application that the blockchain account issuing the digital asset belongs to, and so on.

Digital asset transfer interface: used to provide a function of transferring a digital asset from the first blockchain account to the second blockchain account. The incoming parameters include the serial number of the digital asset, the serial number of the sub-asset included in the digital asset which is a non-fungible token, the unique random number used for signature de-duplication, the identification of the blockchain account currently holding the digital asset, the identification of the blockchain account receiving the digital asset, the public key of the blockchain account currently holding the digital asset, the signature of the blockchain account currently holding the digital asset, the identification of the application that the blockchain account currently holding the digital asset belongs to, and so on.

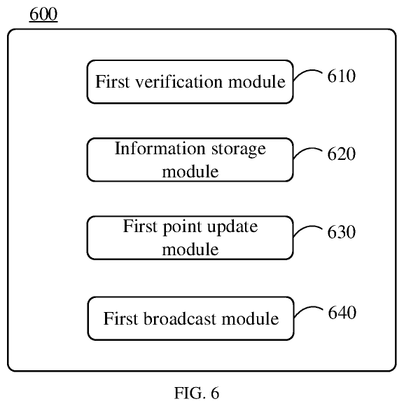

Based on the blockchain-based method of processing the information provided in the present disclosure, the present disclosure further provides a blockchain-based apparatus of processing an information, which will be described in detail below with reference to FIG. 6.

FIG. 6 shows a structural block diagram of a blockchain-based apparatus of processing an information according to embodiments of the present disclosure.

As shown in FIG. 6, an apparatus 600 of processing an information of such embodiments may include a first verification module 610, an information storage module 620, a first point update module 630, and a first broadcast module 640. The apparatus 600 of processing the information may be provided in, for example, any blockchain node in the blockchain network.

The first verification module 610 may be used to verify a transaction request in response to the transaction request being received. The transaction request may include a transaction information and an incentive information for the transaction information. The incentive information may include a first quantity of incentive points, and each incentive point corresponds to a first predetermined quantity of resources. In an embodiment, the first verification module 610 may be used to perform operation S310 described above, which will not be repeated here.

The information storage module 620 may be used to store the transaction information on a blockchain in response to the transaction request being verified successfully, so as to obtain an updated blockchain. In an embodiment, the information storage module 620 may be used to perform operation S320 described above, which will not be repeated here.

The first point update module 630 may be used to update a first existing incentive point according to the incentive information, so as to obtain an updated incentive point. In an embodiment, the first point update module 630 may be used to perform operation S330 described above, which will not be repeated here.

The first broadcast module 640 may be used to broadcast the updated blockchain and the updated incentive point to a plurality of blockchain nodes in a blockchain network. In an embodiment, the first broadcast module 640 may be used to perform operation S340 described above, which will not be repeated here.

According to embodiments of the present disclosure, the incentive information includes a first point transfer path. The first verification module 610 may include a first verification sub-module and a determination sub-module. The first verification sub-module may be used to call a smart contract for incentive points to verify the incentive information, so as to determine whether the first point transfer path belongs to a predetermined path. The determination sub-module may be used to determine that the incentive information is verified successfully, in response to the first point transfer path belonging to the predetermined path.

According to embodiments of the present disclosure, the apparatus 600 of processing the information may further include a second broadcast module, a second verification module, and a verification determination module. The second broadcast module may be used to broadcast a point exchange request to at least some of the plurality of blockchain nodes in response to the point exchange request being received, and the point exchange request includes a second point transfer path. The second verification module may be used to call a smart contract for incentive points to verify the point exchange request, so as to determine whether the second point transfer path belongs to a predetermined path. The verification determination module may be used to determine that the point exchange request is verified successfully, in response to the second point transfer path belonging to the predetermined path. Accordingly, the first point update module is further used to update the first existing incentive point according to the point exchange request, in response to a target information being received from a predetermined proportion of nodes in the at least some nodes. The target information indicates that the point exchange request is verified successfully. The point exchange request further includes a second quantity of incentive points requested for exchange and a third quantity of resources, and the third quantity of resources corresponds to the second quantity of incentive points.

According to embodiments of the present disclosure, the predetermined path includes a predetermined blockchain account, and the predetermined blockchain account includes a management account of each application in at least two applications. Each application is provided with at least two blockchain accounts, and the at least two blockchain accounts include one of the management accounts.

According to embodiments of the present disclosure, the transaction request is broadcast to a consensus node in the blockchain network by a node in the plurality of blockchain nodes, the transaction information is stored on the blockchain by the consensus node, and the first existing incentive point is an existing incentive point of the consensus node storing the transaction information.

According to embodiments of the present disclosure, the incentive point is issued with a generation of a genesis block of the blockchain, and a total quantity of the incentive points is a second predetermined quantity after the generation of the genesis block.

According to embodiments of the present disclosure, the transaction request includes at least one selected from: a first request to issue a digital asset to the blockchain; and a second request to transfer a digital asset from a first blockchain account to a second blockchain account.

According to embodiments of the present disclosure, the transaction information includes a signature of a transaction request account and a public key of the transaction request account. The first verification module 610 may include a second verification sub-module used to call a smart contract for digital assets to verify the transaction information according to the signature and the public key.

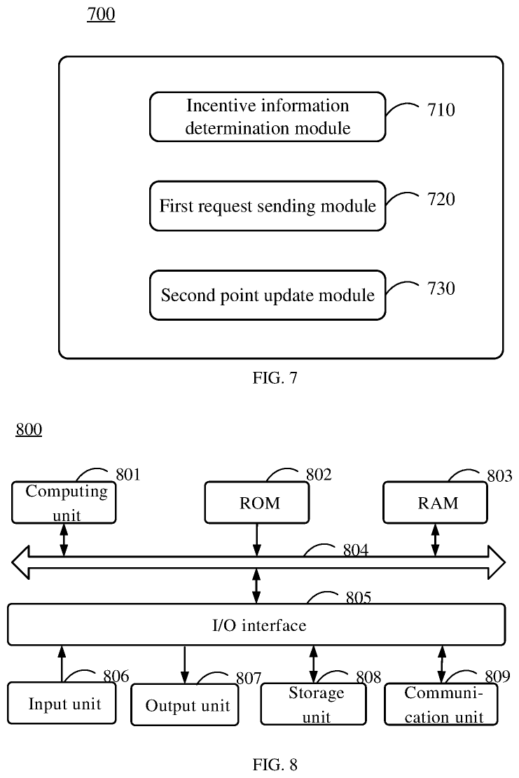

Based on the service end-based method of processing the information provided in the present disclosure, the present disclosure further provides a service end -based apparatus of processing an information, which will be described in detail below with reference to FIG. 7.

FIG. 7 shows a structural block diagram of a service end-based apparatus of processing an information according to embodiments of the present disclosure.

As shown in FIG. 7, an apparatus 700 of processing an information according to such embodiments may include an incentive information determination module 710, a first request sending module 720, and a second point update module 730.

The incentive information determination module 710 may be used to determine an incentive information for a transaction information in response to the transaction information being received. The incentive information includes a first quantity of incentive points, and each incentive point corresponds to a first predetermined quantity of resources. In an embodiment, the incentive information determination module 710 may be used to perform operation S210 described above, which will not be repeated here.

The first request sending module 720 may be used to send a transaction request including the transaction information and the incentive information to a blockchain network to store the transaction information on a blockchain. In an embodiment, the first request sending module 720 may be used to perform operation S220 described above, which will not be repeated here.

The second point update module 730 may be used to update a second existing incentive point according to the incentive information. In an embodiment, the second point update module 730 may be used to perform operation S230 described above, which will not be repeated here.

According to embodiments of the present disclosure, the apparatus 700 of processing the information may further include a second request sending module used to send a point exchange request to the blockchain network in response to the second existing incentive point being less than a predetermined value. The point exchange request includes a second quantity of incentive points requested for exchange and a third quantity of resources. The second point update module 730 may be further used to update the second existing incentive point according to the second quantity. The third quantity of resources corresponds to the second quantity of incentive points.

According to embodiments of the present disclosure, the second existing incentive point is an existing incentive point of a target account, and the target account is a management account of an application in at least two applications. Each application in the at least two applications is provided with at least two blockchain accounts, and the at least two blockchain accounts include one of the management accounts. The transaction information is transmitted by a blockchain account contained in the application the target account belongs to.

According to embodiments of the present disclosure, the transaction information includes an identification information of a digital asset to be traded. The apparatus 700 of processing the information may further include a state determination module used to determine, according to the identification information, a state information of the digital asset to be traded. The incentive information is determined in response to the state information indicating that the digital asset to be traded is allowed to be traded.

It should be noted that in the technical solution of the present disclosure, an acquisition, a storage, a use, a processing, a transmission, a provision, a disclosure, and an application of user personal information involved comply with provisions of relevant laws and regulations, take essential confidentiality measures, and do not violate public order and good custom. In the technical solution of the present disclosure, authorization or consent is obtained from the user before the user's personal information is obtained or collected.

According to embodiments of the present disclosure, the present disclosure further provides an electronic device, a readable storage medium, and a computer program product.

FIG. 8 shows a schematic block diagram of an example electronic device 800 suitable for implementing the method of processing the information according to embodiments of the present disclosure. The electronic device is intended to represent various forms of digital computers, such as a laptop computer, a desktop computer, a workstation, a personal digital assistant, a server, a blade server, a mainframe computer, and other suitable computers. The electronic device may further represent various forms of mobile devices, such as a personal digital assistant, a cellular phone, a smart phone, a wearable device, and other similar computing devices. The components as illustrated herein, and connections, relationships, and functions thereof are merely examples, and are not intended to limit the implementation of the present disclosure described and/or required herein.

As shown in FIG. 8, the electronic device 800 includes a computing unit 801 which may perform various appropriate actions and processes according to a computer program stored in a read only memory (ROM) 802 or a computer program loaded from a storage unit 808 into a random access memory (RAM) 803. In the RAM 803, various programs and data necessary for an operation of the electronic device 800 may also be stored. The computing unit 801, the ROM 802 and the RAM 803 are connected to each other through a bus 804. An input/output (I/O) interface 805 is also connected to the bus 804.

A plurality of components in the electronic device 800 are connected to the I/O interface 805, including: an input unit 806, such as a keyboard, or a mouse; an output unit 807, such as displays or speakers of various types; a storage unit 808, such as a disk, or an optical disc; and a communication unit 809, such as a network card, a modem or a wireless communication transceiver. The communication unit 809 allows the electronic device 800 to exchange information/data with other devices through a computer network such as Internet and/or various telecommunication networks.

The computing unit 801 may be various general-purpose and/or dedicated processing assemblies having processing and computing capabilities. Some examples of the computing units 801 include, but are not limited to, a central processing unit (CPU), a graphics processing unit (GPU), various dedicated artificial intelligence (Al) computing chips, various computing units that run machine learning model algorithms, a digital signal processing processor (DSP), and any suitable processor, controller, microcontroller, etc. The computing unit 801 executes various methods and steps described above, such as the method of processing the information. For example, in some embodiments, the method of processing the information may be implemented as a computer software program which is tangibly embodied in a machine-readable medium, such as the storage unit 808. In some embodiments, the computer program may be partially or entirely loaded and/or installed in the electronic device 800 via the ROM 802 and/or the communication unit 809. The computer program, when loaded in the RAM 803 and executed by the computing unit 801, may execute one or more steps in the method of processing the information described above. Alternatively, in other embodiments, the computing unit 801 may be configured to perform the method of processing the information by any other suitable means (e.g., by means of firmware).

Various embodiments of the systems and technologies described herein may be implemented in a digital electronic circuit system, an integrated circuit system, a field programmable gate array (FPGA), an application specific integrated circuit (ASIC), an application specific standard product (ASSP), a system on chip (SOC), a complex programmable logic device (CPLD), a computer hardware, firmware, software, and/or combinations thereof. These various embodiments may be implemented by one or more computer programs executable and/or interpretable on a programmable system including at least one programmable processor. The programmable processor may be a dedicated or general-purpose programmable processor, which may receive data and instructions from a storage system, at least one input device and at least one output device, and may transmit the data and instructions to the storage system, the at least one input device, and the at least one output device.

Program codes for implementing the methods of the present disclosure may be written in one programming language or any combination of more programming languages. These program codes may be provided to a processor or controller of a general-purpose computer, a dedicated computer or other programmable data processing apparatus, such that the program codes, when executed by the processor or controller, cause the functions/operations specified in the flowcharts and/or block diagrams to be implemented. The program codes may be executed entirely on a machine, partially on a machine, partially on a machine and partially on a remote machine as a stand-alone software package or entirely on a remote machine or server.

In the context of the present disclosure, a machine-readable medium may be a tangible medium that may contain or store a program for use by or in connection with an instruction execution system, an apparatus or a device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination of the above. More specific examples of the machine-readable storage medium may include an electrical connection based on one or more wires, a portable computer disk, a hard disk, a random access memory (RAM), a read only memory (ROM), an erasable programmable read only memory (EPROM or a flash memory), an optical fiber, a compact disk read only memory (CD-ROM), an optical storage device, a magnetic storage device, or any suitable combination of the above.

In order to provide interaction with the user, the systems and technologies described here may be implemented on a computer including a display device (for example, a CRT (cathode ray tube) or LCD (liquid crystal display) monitor) for displaying information to the user, and a keyboard and a pointing device (for example, a mouse or a trackball) through which the user may provide the input to the computer. Other types of devices may also be used to provide interaction with the user. For example, a feedback provided to the user may be any form of sensory feedback (for example, visual feedback, auditory feedback, or tactile feedback), and the input from the user may be received in any form (including acoustic input, voice input or tactile input).

The systems and technologies described herein may be implemented in a computing system including back-end components (for example, a data server), or a computing system including middleware components (for example, an application server), or a computing system including front-end components (for example, a user computer having a graphical user interface or web browser through which the user may interact with the implementation of the system and technology described herein), or a computing system including any combination of such back-end components, middleware components or front-end components. The components of the system may be connected to each other by digital data communication (for example, a communication network) in any form or through any medium. Examples of the communication network include a local area network (LAN), a wide area network (WAN), and the Internet.

A computer system may include a client and a server. The client and the server are generally far away from each other and usually interact through a communication network. The relationship between the client and the server is generated through computer programs running on the corresponding computers and having a client-server relationship with each other. The server may be a cloud server, also known as a cloud computing server or a cloud host, which is a host product in a cloud computing service system to solve shortcomings of difficult management and weak service scalability existing in an existing physical host and VPS (Virtual Private Server) service. The server may also be a server of a distributed system or a server combined with a block-chain.

It should be understood that steps of the processes illustrated above may be reordered, added or deleted in various manners. For example, the steps described in the present disclosure may be performed in parallel, sequentially, or in a different order, as long as a desired result of the technical solution of the present disclosure may be achieved. This is not limited in the present disclosure.

The above-mentioned specific embodiments do not constitute a limitation on the scope of protection of the present disclosure. Those skilled in the art should understand that various modifications, combinations, sub-combinations and substitutions may be made according to design requirements and other factors. Any modifications, equivalent replacements and improvements made within the spirit and principles of the present disclosure shall be contained in the scope of protection of the present disclosure.

What is claimed is:

1. A method of processing an information, the method comprising:
verifying a transaction request in response to the transaction request being received, wherein the transaction request comprises a transaction information and an incentive information for the transaction information;
storing the transaction information on a blockchain in response to the transaction request being verified successfully, so as to obtain an updated blockchain;
updating a first existing incentive point according to the incentive information, so as to obtain an updated incentive point; and
broadcasting the updated blockchain and the updated incentive point to a plurality of blockchain nodes in a blockchain network,
wherein the incentive information comprises a first quantity of incentive points, and each incentive point corresponds to a first predetermined quantity of resources.

2. The method according to claim 1, wherein the incentive information comprises a first point transfer path; and
wherein the verifying a transaction request in response to the transaction request being received comprises:
calling a smart contract for incentive points to verify the incentive information, so as to determine whether the first point transfer path belongs to a predetermined path; and
determining that the incentive information is verified successfully, in response to the first point transfer path belonging to the predetermined path.

3. The method according to claim 1, further comprising:
broadcasting a point exchange request to at least some of the plurality of blockchain nodes in response to the point exchange request being received, wherein the point exchange request comprises a second point transfer path;
calling a smart contract for incentive points to verify the point exchange request, so as to determine whether the second point transfer path belongs to a predetermined path;
determining that the point exchange request is verified successfully, in response to the second point transfer path belonging to the predetermined path; and
updating the first existing incentive point according to the point exchange request, in response to a target information being received from a predetermined proportion of nodes in the at least some nodes, wherein the target information indicates that the point exchange request is verified successfully,
wherein the point exchange request further comprises a second quantity of incentive points requested for exchange and a third quantity of resources, and the third quantity of resources corresponds to the second quantity of incentive points.

4. The method according to claim 2, wherein:
the predetermined path comprises a predetermined blockchain account;
the predetermined blockchain account comprises a management account of each application in at least two applications; and
each application is provided with at least two blockchain accounts, and the at least two blockchain accounts comprise one of the management accounts.

5. The method according to claim 1, wherein:
the transaction request is broadcast to a consensus node in the blockchain network by a node in the plurality of blockchain nodes; and
the transaction information is stored on the blockchain by the consensus node, and the first existing incentive point is an existing incentive point of the consensus node storing the transaction information.

6. The method according to claim 1, wherein the incentive point is issued with a generation of a genesis block of the blockchain, and a total quantity of the incentive points is a second predetermined quantity after the generation of the genesis block.

7. The method according to claim 1, wherein the transaction request comprises at least one selected from:
a first request to issue a digital asset to the blockchain; and/or
a second request to transfer a digital asset from a first blockchain account to a second blockchain account.

8. The method according to claim 1, wherein the transaction information comprises a signature of a transaction request account and a public key of the transaction request account; and
wherein the verifying a transaction request comprises calling a smart contract for digital assets to verify the transaction information according to the signature and the public key.

9. The method according to claim 3, wherein:
the predetermined path comprises a predetermined blockchain account;
the predetermined blockchain account comprises a management account of each application in at least two applications; and
each application is provided with at least two blockchain accounts, and the at least two blockchain accounts comprise one of the management accounts.

10. A method of processing an information, the method comprising:
determining an incentive information for a transaction information in response to the transaction information being received;
sending a transaction request to a blockchain network to store the transaction information on a blockchain, wherein the transaction request comprises the transaction information and the incentive information; and
updating a second existing incentive point according to the incentive information,
wherein the incentive information comprises a first quantity of incentive points, and each incentive point corresponds to a first predetermined quantity of resources.

11. The method according to claim 10, further comprising:
sending a point exchange request to the blockchain network in response to the second existing incentive point being less than a predetermined value, wherein the point exchange request comprises a second quantity of incentive points requested for exchange and a third quantity of resources; and
updating the second existing incentive point according to the second quantity,
wherein the third quantity of resources corresponds to the second quantity of incentive points.

12. The method according to claim 10, wherein:
the second existing incentive point is an existing incentive point of a target account, and the target account is a management account of an application in at least two applications;
each application in the at least two applications is provided with at least two blockchain accounts, and the at least two blockchain accounts comprise one of the management accounts; and
wherein the transaction information is transmitted by a blockchain account contained in the application the target account belongs to.

13. The method according to claim 10, wherein the transaction information comprises an identification information of a digital asset to be traded; and
further comprising determining, according to the identification information, a state information of the digital asset to be traded, wherein the incentive information is determined in response to the state information indicating that the digital asset to be traded is allowed to be traded.

14. An electronic device, comprising:
at least one processor; and
a memory communicatively connected to the at least one processor, wherein the memory stores instructions executable by the at least one processor, the instructions, when executed by the at least one processor, configured to cause the at least one processor to implement at least the method of claim 1.

15. The electronic device according to claim 14, wherein the incentive information comprises a first point transfer path; and
the instructions are further configured to cause the at least one processor to:
call a smart contract for incentive points to verify the incentive information, so as to determine whether the first point transfer path belongs to a predetermined path; and
determine that the incentive information is verified successfully, in response to the first point transfer path belonging to the predetermined path.

16. The electronic device according to claim 14, wherein the instructions are further configured to cause the at least one processor to:
broadcast a point exchange request to at least some of the plurality of blockchain nodes in response to the point exchange request being received, wherein the point exchange request comprises a second point transfer path;
call a smart contract for incentive points to verify the point exchange request, so as to determine whether the second point transfer path belongs to a predetermined path;
determine that the point exchange request is verified successfully, in response to the second point transfer path belonging to the predetermined path; and
update the first existing incentive point according to the point exchange request, in response to a target information being received from a predetermined proportion of nodes in the at least some nodes, wherein the target information indicates that the point exchange request is verified successfully,
wherein the point exchange request further comprises a second quantity of incentive points requested for exchange and a third quantity of resources, and the third quantity of resources corresponds to the second quantity of incentive points.

17. The electronic device according to claim 15, wherein:
the predetermined path comprises a predetermined blockchain account;
the predetermined blockchain account comprises a management account of each application in at least two applications; and
each application is provided with at least two blockchain accounts, and the at least two blockchain accounts comprise one of the management accounts.

18. An electronic device, comprising:
at least one processor; and
a memory communicatively connected to the at least one processor, wherein the memory stores instructions executable by the at least one processor, the instructions, when executed by the at least one processor, configured to cause the at least one processor to implement at least the method of claim 10.

19. A non-transitory computer-readable storage medium having computer instructions therein, the computer instructions configured to cause a computer system to implement at least the method of claim 1.

20. A non-transitory computer-readable storage medium having computer instructions therein, the computer instructions configured to cause a computer system to implement at least the method of claim 10.
